(19) United States
(12) Patent Application Publication
(10) Pub. No.: US 2022/0388721 A1
(43) Pub. Date: Dec. 8, 2022

(54) RETAINER

(71) Applicant: GPA GLOBAL UK LIMITED, Hertfordshire (GB)

(72) Inventor: Toby Wilson, Hertfordshire (GB)

(21) Appl. No.: 17/775,462

(22) PCT Filed: Nov. 6, 2020
(86) PCT No.: PCT/GB2020/052811

§ 371 Date: May 9, 2022

(30) Foreign Application Priority Data
Nov. 8, 2019 (GB) 1916289.0

(51) Int. Cl. B65D 25/10; A61J 9/06; B65D 81/05

(52) U.S. Cl. CPC B65D 25/108; A61J 9/0661; A61J 9/0646; B65D 81/05

(57) ABSTRACT

A retainer (1) for releasably retaining an item, such as a bottle, is described. The retainer comprises a housing (19); and a latch. The latch is configurable between: i) an unlocked state for insertion of the item into, or removal of the item from, the housing, in which the latch is movable between an open position and a closed position; and ii) a locked state for retaining the item in the housing, in which the latch is maintained in the closed position. Configuration between the locked state and the unlocked state is effected by a change in orientation of the retainer.

The invention relates to a retainer for securely and releasably retaining an item, such as a bottle, and methods of retaining such items.

With the rise of e-commerce, the packaging of items has taken on a greater significance. For fragile items, such as bottles or the like, it is important that items survive in transit. However, when independent courier services are transporting items, often in isolation, manufacturers or distributors may not be able to maintain control of how items are transported, meaning that the risk of breakages may be higher. Substantial packaging, such as multiple boxes and bubble wrap, are conventionally used to reduce breakages, but such additional packaging may be wasteful.

For certain items, such as luxury items or gift items, it is also desirable for the packaging to maintain an aesthetic appeal. For such items, protective measures such as cardboard boxes and bubble wrap, may not be an adequate solution. Items such as glass bottles containing alcoholic beverages may be transported in gift boxes which look attractive, but the protective measures included in such boxes, such as shredded paper or padding, may not adequately secure the bottles, such that the bottles are still able to move within the packaging and risk breaking.

It would be beneficial if packaging could continue to provide a protective role post-transit, such as when an item is being displayed in a store or, or is being kept at the residence of a consumer. It would also be advantageous if an item could be readily removed from secure packaging and even more advantageous if the secure packaging could be reused to store the item. This may not be the case for items transported in boxes in which the item is secured to or retained in the box using, for instance, a single-use fastener such as a clip or cable-tie. Such clips are often difficult to remove and cannot be reused.

A retainer has been devised which may overcome the aforementioned disadvantages.

According to the invention, there is provided a retainer for releasably retaining an item, the retainer comprising: a housing; and a latch which is configurable between: i) an unlocked state for insertion of the item into, or removal of the item from, the housing, in which the latch is movable between an open position and a closed position; and ii) a locked state for retaining the item in the housing, in which the latch is maintained in the closed position.

Configuration between the locked state and the unlocked state is effected by a change in orientation of the retainer.

Configuration of the locked state may thus automatically occur when the retainer is moved into an orientation in which the item is likely to fall out of the retainer. In one example, the change in orientation of the retainer comprises a change in inclination of the retainer and/or a rotation of retainer.

If, for instance, the retainer is maintained in an upright position the item may be readily inserted into the retainer and removed from the retainer. However, if the retainer is tilted whilst the item is in retainer, the locking mechanism may be engaged such that the item is secured and is prevented from falling out of the retainer. For example, an inclination or tilt of the retainer at least 20 degrees, 30 degrees or 45 degrees relative to a vertical orientation may configure the locked state from the unlocked state.

The retainer may thus employ a gravity locking mechanism. The mechanism may automatically engage if the retainer is moved into a position that would otherwise mean that the item in the retainer is at risk of falling out under the influence of gravity. For example, one may envisage a retainer of the invention adapted for retaining a glass bottle. If the retainer is upright, such as if it is on a shelf in a warehouse, the bottle may be readily inserted into, and removed from, the retainer. When the retainer is tilted or rotated during transit, configuration of the locked state would mean that the bottle would be securely retained by the retainer. Once the retainer and the bottle have been transported, and are once again put in an upright position, such as on a shelf of a consumer's residence or in a store, the bottle can be readily removed from the retainer. Furthermore, the bottle may be placed back into the retainer when not in use, to enable continued secure storage.

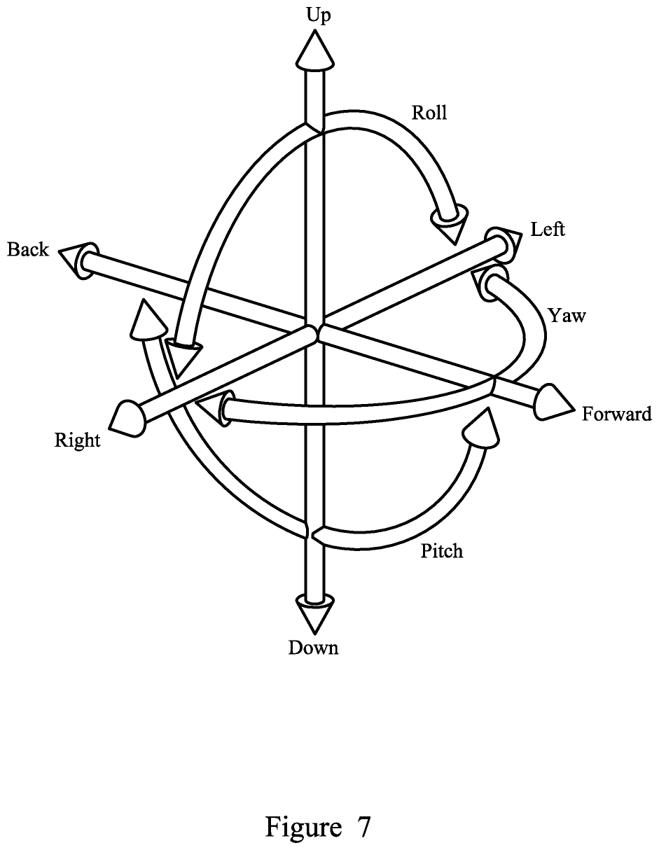

Rotation or inclination of the retainer in a particular plane of rotation may configure the locked state and the unlocked state. In one embodiment, with reference to FIG. 7, tilting the retainer in the pitch plane of rotation may configure the locked state. The configuration of the locked configuration may depend on the direction of rotation or inclination in the pitch plane of rotation. For instance, tilting the retainer such that the top of the retainer is tilted forwards, may initiate the locked state. This may be the case, if the retainer is included in a box with an opening at the front, such that tilting the retainer forwards would otherwise cause the item to fall out of the box.

Other changes in orientation may initiate the locked state. For example, if the retainer is in a horizontal position with the front of the retainer facing upwards, rotation of the retainer in the roll plane, may initiate the locked state.

The retainer may comprise a mobile locking member for configuring the locked state and the unlocked state. As the retainer changes orientation, the mobile locking member may change position. The mobile locking member may comprise a ball or a roller.

The locking member may move between: i) a first (resting) position, in the unlocked state, which does not resist the latch being urged to an open position; and ii) a second (locking) position, in the locked state, which resists the latch being urged to an open position. For example, in its second position, the locking member may maintain the latch in the locked state, such as by wedging the latch in the locked state. The mobile locking member may move within a channel or track defined in the housing and/or defined in the latch. Movement of the locking member between the first and second positions may only be permitted when the latch is in the open position. For instance, the channel or track may only be defined when the latch is in the open position.

In a preferred embodiment, the retainer comprises a resilient biasing means for urging the latch to the closed position. This may be in the form of a spring, such as a torsion spring. Consequently, when the latch is urged to the open position, such as when the item is inserted into the housing, it may automatically rebound to the closed position.

In one embodiment, the latch comprises at least one arm, or flap, movably attached to the housing, preferably rotatably or pivotally attached to the housing. Preferably there are two arms movably (preferably rotatably or pivotally) attached to the housing. Movement of the arm, for example rotation of the arm, may thus effect the open and closed positions.

The housing may define a cavity, chamber or recess into which the item is positioned, in use. The arm or arms may extend or protrude into the recess, such as into the entrance of the recess. Moving the arm or arms into an open position, such that the or each arm protrudes into the recess to a lesser extent, may allow passage of the item into the recess. Once the item is positioned into the recess, the arm or arms may move, or be movable, to the closed position in which the or each arm protrudes into the recess to a greater extent. The movement back to the closed position may be automatic if, for example, the retainer comprises a resilient biasing means for urging the arm to the closed position. In the locked state, the arm in the closed position may thus provide a barrier against removal of the item from the recess.

The arm or arms may be shaped such that the item may be efficiently inserted and removed from the housing, particularly if the item itself can be used to urge the arm or arms into an open position. This may be achieved by the arm or arms having a curved surface or curved edge. For example, a part of the arm which contacts the item during insertion and removal, such as the part which protrudes into the recess, may form a convex curve. This may be particularly preferably if the item is a bottle with a substantially circular or elliptical cross-section and the arms contact a portion of the bottle such as the bottle neck.

As described herein, the mobile locking member may wedge the latch in the locked state. If the retainer comprises one or more arms (e.g. rotatable or pivotable arms), the locking member may form a wedge between the housing and the or each arm, to prevent the arm from being urged into the open position. In one embodiment, the arm may comprise a shaped portion (e.g. having a notch and/or a projection), which accommodates or fits a correspondingly shaped portion of the housing (e.g. having a notch and/or projection). The correspondingly shaped portions may permit at least a part of the or each arm to move into the housing, to the open position. When the or each arm is in the closed position, the mobile locking member may be movable into a position in between the correspondingly shaped portions of the or each arm and the housing, to prevent the arm moving into the housing into the open position.

A surface of the arm which contacts the mobile locking member may be sloped such that the mobile locking member wedges the arm when the retainer is tilted/reclined and/or rotated. The extent of the slope may thus dictate the extent to which the retainer must be tilted to configure the locked state. The sloped surface may also prevent the locked state being configured unintentionally, for example when the retainer is substantially upright.

In one embodiment, the retainer is a bottle retainer adapted to retain a bottle, such as a glass bottle. However, it is envisaged that a retainer of the invention is capable of a wide range of applications. For example, the retainer may be adapted to retain items such as consumer goods, e.g. cell phones, tablets and laptops. The retainer may be adapted for use in marine applications, such as on a vessel e.g. a boat, when it is desirable to retain equipment when a vessel is rolling, pitching and/or yawing.

According to the invention, there is provided a retainer of the invention, in combination with an item. The retainer may releasably retain the item in the housing. The item may be a container or receptacle, such as a glass container or receptacle, preferably a bottle.

If the item is a bottle, the latch may be positioned to contact a neck and/or lid of the bottle, in use. The latch may contact only the neck and/or lid. The neck and/or lid of the bottle may thus be retained within the housing, for example within the cavity defined in the housing.

According to the invention, there is provided a box comprising a retainer of the invention.

The box may comprise a base unit for securing a base of the item, whilst the item is retained in the housing. For example, the base may define a ridge or well for securing the base of the item.

The box may comprise the base unit at a base of the box and the retainer at a top of the box. For example, if the item is a bottle, the retainer may retain the neck and/or lid of the bottle, whereas the base unit may accommodate the base of the bottle. A side, end or front of the box may define an opening through which the item is inserted, and removed from, the box, in use. The opening may allow visualisation of the item when it is in the box and is engaged with the retainer. The retainer may secure the item and prevent it from falling out of the box when inclined or rotated.

According to the invention, there is provided a method for releasably retaining an item, comprising inserting an item into a housing of a retainer, when a latch of the retainer is in unlocked state and is movable between an open position and a closed position; and changing the orientation of the retainer to configure the latch into a closed state to maintain the latch in the closed position and retain the item in the housing. The retainer may be as described herein. The retainer may be in a box, as described herein. The item may be as described herein, preferably a bottle.

The method may comprise changing the orientation of the retainer that is retaining the item, to configure the latch, into the unlocked state; and removing the item from the housing.

Changing the orientation of the retainer may comprise changing the inclination of the retainer and/or a rotating the retainer. Configuring the locked state from the unlocked state may comprises inclining the retainer at least 20 degrees, 30 degrees or 45 degrees relative to a vertical orientation.

Embodiments of the invention will now be described, by way of example, with reference to the accompanying drawings in which:

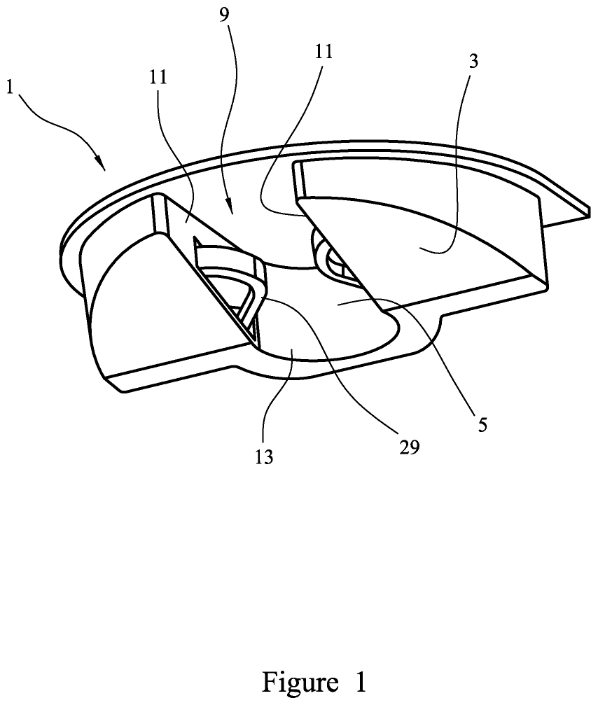

FIG. 1 shows a three dimensional view of a bottle retainer of the invention;

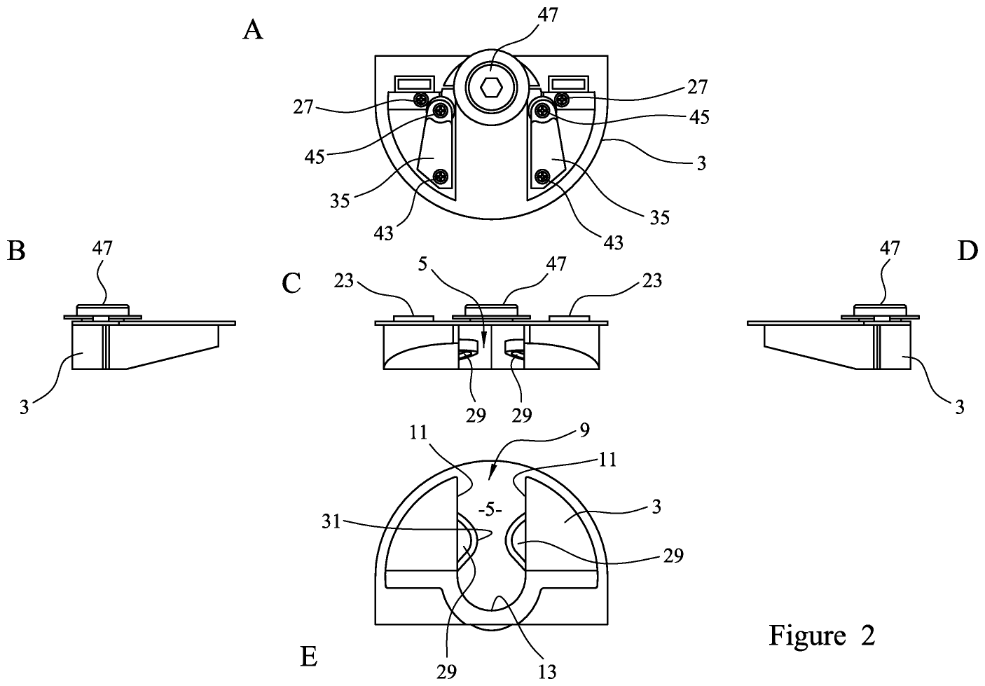

FIG. 2 shows top (A), left side (B), front (C), right side (D) and bottom (E) views of the retainer of FIG. 1;

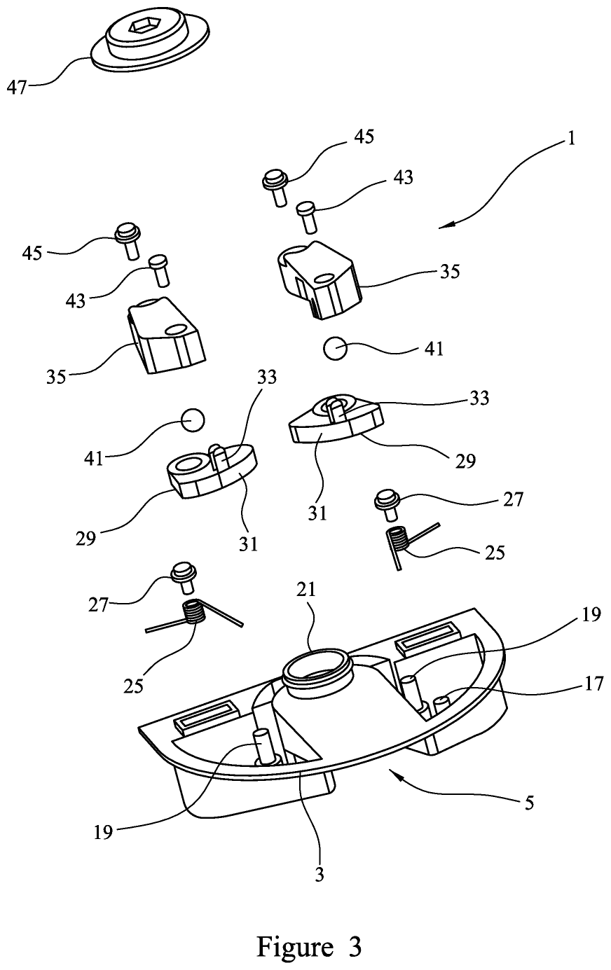

FIG. 3 shows an exploded view of a retainer of FIGS. 1 and 2;

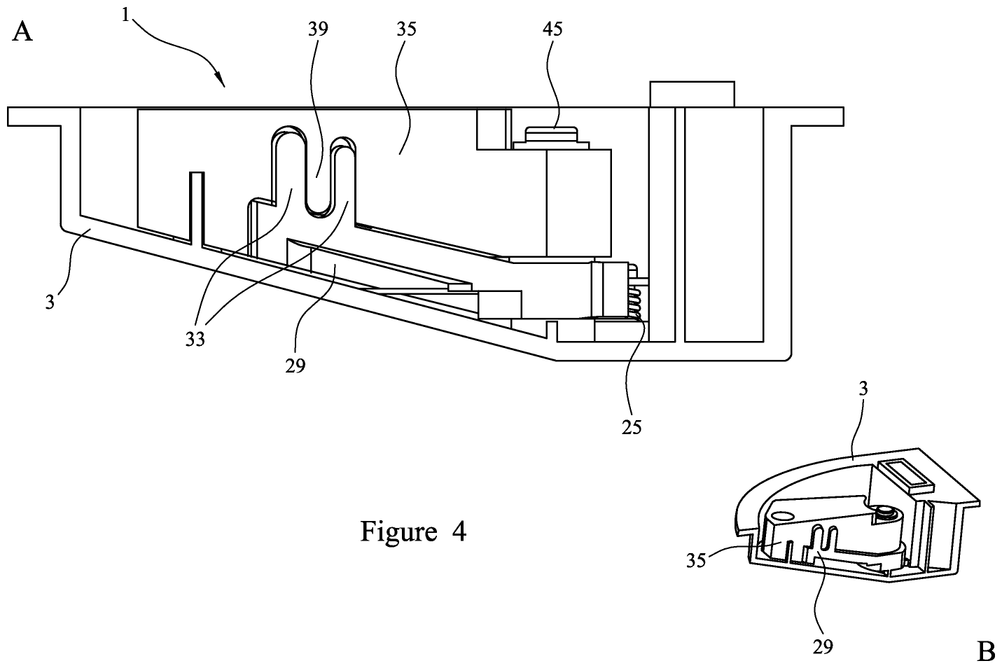

FIG. 4 shows views, in section, of the retainer of FIGS. 1 to 3 in an open, unlocked state (A: side view; B: three dimensional view);

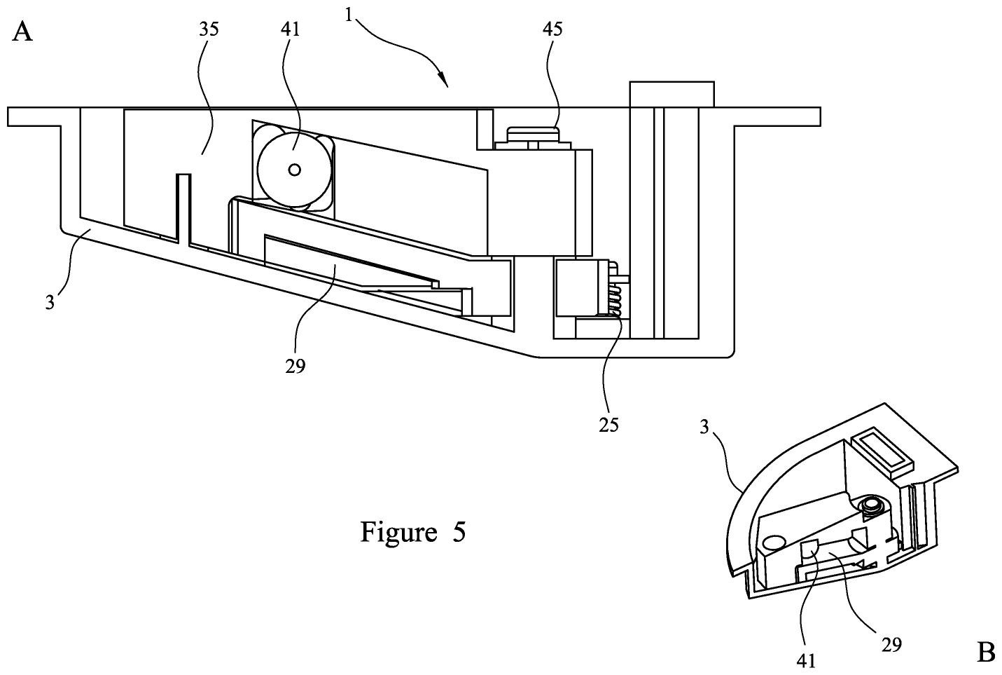

FIG. 5 shows views in section of the retainer of FIGS. 1 to 4 in a close, locked state (A: side view; B: three dimensional view);

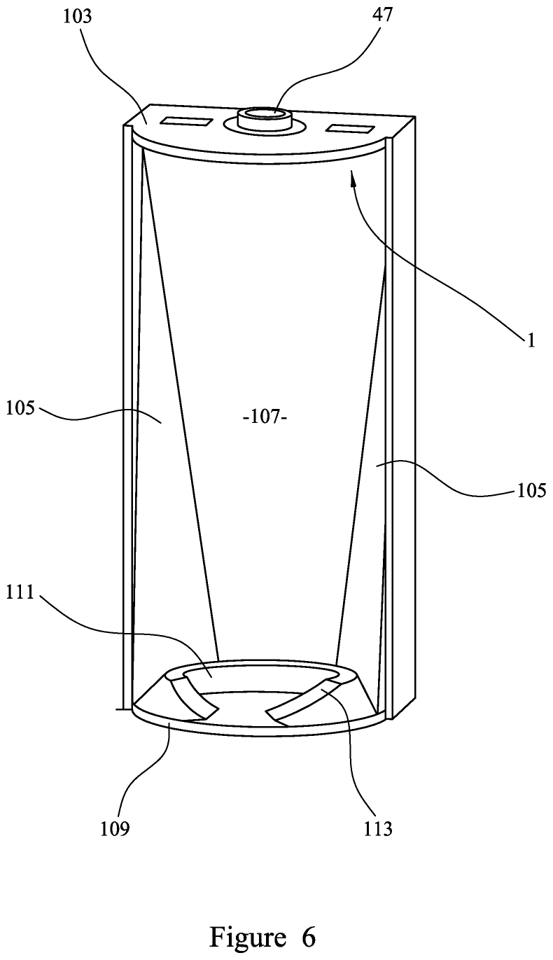

FIG. 6 shows a three dimensional view of a box encompassing the retainer of FIGS. 1 to 5;

FIG. 7 illustrates degrees of freedom of a retainer.

A bottle retainer 1 as shown in FIGS. 1 to 5 has a fitment unit 3. The fitment unit defines a recess 5 on its underside, the recess having an opening 9 at the front of the fitment unit, side-walls 11 and a back wall 13 at the rear of the fitment unit. The top side of the fitment unit defines two front screw housings 17, two rear screw housings 19, and a central locking thread 21.

Two torsion springs 25 are attached to the fitment unit 3 by screws 27. Two arms 29, each with curved inner edges 31 and a pair of perpendicular projections 33 on the top sides, are positioned over the torsion springs. A notch is defined between the two perpendicular projections. The top side of each arm is upwardly sloped from the rear to the front.

Ball bearing housings 35 are positioned over each arm 29, each ball bearing housing defining a cavity 37 and perpendicular projection 39 on its underside. A ball bearing 41 is accommodated within each cavity of each ball bearing housing and contacts the top side of each arm. The ball bearing housings are connected to the fitment unit 3 by front screws 43 and rear screws 45 which engage with the corresponding front screw housings 17 and rear screw housings 19 on the top side of the fitment unit. The rear screws 45 are also rotatably attached the arms to the fitment unit and the ball bearing housings by the rear screws.

A top screw lock 47 engages with the central locking thread 21 on the top side of 15 of the fitment unit 3.

In use, when the retainer 1 is upright, the arms 29 are in a closed position, such that they project inwardly into the recess 5 of the fitment unit 3, urged by the torsion springs 25.

However, the arms are in an unlocked state and can be readily moved into an open position in which the arms are rotated outwardly. In the open position, the arms are positioned underneath the ball bearing housings 35 to a greater extent and such that they project into the cavity of the fitment unit to a lesser extent. In the open position, the projection 39 on the underside of each ball bearing housing fits within the correspondingly-shaped notch defined between the pair of projections 33 on the top side of the arm (as shown in FIG. 4).

Inserting the neck of the bottle into the recess 5 of the fitment unit 3, through the recess opening 9 contacts the neck of the bottle with the curved inner edges 31 of the arms 29 and urges the arms into the open position. Once the neck of the bottle has passed beyond the arms, towards the back wall 13 of the fitment unit, the arms rebound into the closed position, urged by the torsion springs 25. However, as long as the retainer 1 and the bottle remain upright, the arms will be in an unlocked state.

In the unlocked state, one may readily remove the bottle from the retainer 1 by pulling the bottle out of the recess 5 of the fitment unit 3. Pulling the bottle away from the back wall 13 of the fitment unit toward the opening 9 of the recess contacts the bottle with the curved inner edges 31 of the arms 29, urging them to the outward position.

The locked state is configured by a forward inclination, or pitching, of the retainer 1. The forward inclination causes the ball bearings 41 in the ball bearing housings 37 to move forwards from a resting position, up the slopes on the topside of each arm 29, to a locking position between the projection 39 on the underside of each ball bearing housing and the notch between the pair of projections 33 on the topside of the arm. This position prevents the arm from rotating underneath the ball bearing housing, thus preventing the arms from being moved into the open position (as shown in FIG. 5). The bottle is thus retained in the retainer and is prevented from falling out. When the retainer and the bottle return to an upright position, the ball bearing rolls back to the resting position, configuring the unlocked state.

When the arms 29 are in an open position, the ball bearings 41 are not able to move to the locking position. A passageway for each ball bearing is only defined when the arms are in the open position.

A display box 101, as shown in FIG. 6, has a top 103, left and right side walls 105, a back wall 107 and a base 109. The front of the box is open for insertion and removal of a bottle (not shown).

The bottle retainer 1 of FIGS. 1-5 is attached to the top 103 of the box 101. The retainer is secured in place by the top screw lock 47 engaging with the central locking thread 21 on the top side of the fitment unit, the central locking thread protruding through a hole defined in the top of the box.

On the base 109 of the box 101 is a base moulding 111 with a ridge 113 around an outer edge to define a well. In use, the base of the bottle is retained within the well, whilst the neck of the bottle is retained by the retainer 1. When the box is tilted forwards, the bottle is prevented from falling out of the front of the box by configuration of the locked state.

1. A retainer for releasably retaining an item, the retainer comprising:
a housing; and
a latch which is configurable between:
i) an unlocked state for insertion of the item into, or removal of the item from, the housing, in which the latch is movable between an open position and a closed position; and
ii) a locked state for retaining the item in the housing, in which the latch is maintained in the closed position,
in which configuration between the locked state and the unlocked state is effected by a change in orientation of the retainer.

2. A retainer according to claim 1, in which the change in orientation of the retainer comprises a change in inclination of the retainer and/or a rotation of retainer.

3. A retainer according to claim 2, in which an inclination of the retainer at least 20 degrees, 30 degrees or 45 degrees relative to a vertical orientation configures the locked state from the unlocked state.

4. A retainer according to any preceding claim, comprising a mobile locking member which can move with the change in orientation of the of the retainer.

5. A retainer according to claim 4, in which the locking member moves under the influence of gravity.

6. A retainer according to any preceding claim, in which the locking member comprises a ball or a roller.

7. A retainer according to any preceding claim, in which the locking member can move between: i) a first position, in the unlocked locked state, which does not resist the latch being urged to an open position; and ii) a second position, in the locked state, which resists the latch being urged to an open position.

8. A retainer according to claim 7, in which in its second position, the locking member wedges the latch in the locked state.

9. A retainer according to any preceding claim, comprising a resilient biasing means for urging the latch to the closed position.

10. A retainer according to any preceding claim, in which the latch comprises at least one arm rotatably attached to the housing.

11. A retainer according to claim 10 comprising two arms rotatably attached to the housing.

12. A retainer according to any preceding claim which is a bottle retainer adapted to retain a bottle.

13. A retainer according to claim 12, in which the latch is positioned to contact a neck and/or lid of the bottle, in use.

14. A retainer according to claim 11 or claim 12, in combination with a bottle.

15. A box comprising a retainer as defined in any preceding claim.

16. A box according to claim 15, comprising a base unit for securing a base of the item, whilst the item is retained in the housing.

17. A box according to claim 16, in which the base unit defines a ridge or well, for securing the base of the item.

18. A method for releasably retaining an item, comprising inserting an item into a housing of a retainer, when a latch of the retainer is in unlocked state and is movable between an open position and a closed position; and changing the orientation of the retainer to configure the latch into a closed state to maintain the latch in the closed position and retain the item in the housing.

19. A method according to claim 18, which comprises changing the orientation of the retainer that is retaining the item, to configure the latch, into the unlocked state; and removing the item from the housing.

20. A method according to claim 18 or claim 19, in which changing the orientation of the retainer comprises changing the inclination of the retainer and/or a rotating the retainer.

21. A method according to claim 20, in which configuring the locked state from the unlocked state comprises inclining the retainer at least 20 degrees, 30 degrees or 45 degrees relative to a vertical orientation.

22. A method according to any of claims 18 to 21, in which the item is a bottle.
